(19) United States
(12) Patent Application Publication
(10) Pub. No.: US 2015/0299390 A1
(43) Pub. Date: Oct. 22, 2015

(54) Polymers of [4-(methylether)-1,3-dioxolane-2-one of polyether polyol]

(71) Applicant: BOSTIK SA, La Plaine St Denis (FR)

(72) Inventors: Guillaume MICHAUD, Compiegne (FR); Frederic SIMON, Pont L'Eveque (FR); Stephane FOUQUAY, Mont Saint-Aignan (FR)

(73) Assignee: Bostik SA, La Plaine St Denis (FR)

(21) Appl. No.: 14/440,656

(22) PCT Filed: Oct. 30, 2013
(86) PCT No.: PCT/FR2013/052596

§ 371 Date: May 5, 2015

(30) Foreign Application Priority Data
Nov. 5, 2012 (FR) 1260484

(51) Int. Cl. C08G 65/331; C08G 71/04

(52) U.S. Cl. CPC C08G 65/331; C08G 71/04

(57) ABSTRACT

The invention relates to a polymer of formula (I):

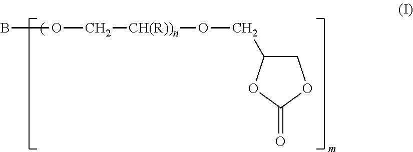

in which R is a hydrogen or an alkyl having from 1 to 4 carbon atoms; m is a number from 1 to 6; B is a monovalent, divalent, trivalent, tetravalent, pentavalent or hexavalent radical comprising from 1 to 44 carbon atoms per molecule; and n is such that the number-average molar mass Mn of the polymer of formula (I) is from 4000 to 18 000 g/mol and its polydispersity (Pd) is within a range from 1.0 to 1.4.

Process for the preparation of the polymer of formula (I).

Process for the preparation of polyurethanes comprising the reaction of a polymer of formula (I) with a compound comprising an amine group, and also poly-urethanes capable of being thus obtained.

A subject matter of the present invention is polymers comprising, at each of their ends, a 1,3-dioxolan-2-one (or cyclocarbonate) end group bonded to a polymer chain via a methyl ether (CH₂—O) functional group substituted at the alpha (α) position of the 1,3-dioxolan-2-one, and their use in the preparation of polyurethanes by reaction with a compound comprising at least one amine group. These polyurethanes, once formulated, are intended to be used in coatings, mastics or adhesives, as additives and/or as resins.

The synthesis of polyurethanes is conventionally carried out by reaction between a diol and a diisocyanate. Diisocyanates are toxic compounds as such and are generally obtained from phosgene, itself highly toxic by inhalation or by contact. The manufacturing process used in industry generally employs the reaction of an amine with an excess of phosgene in order to form an isocyanate.

The search for alternatives for the synthesis of polyurethanes without using isocyanate (or NIPU for “Non Isocyanate Polyurethane”) thus represents a major challenge.

This search has formed the subject of numerous research and development studies. The paths most widely studied relate to the use of polymers, each of the end groups of which comprises a 1,3-dioxolan-2-one group as final part. These polymers react with amines or amine oligomers to form polyurethanes.

However, none of the solutions provided is satisfactory.

The patent application EP 1 088 021, from Eurotech Ltd, describes 1,3-dioxolan-2-one oligomer compounds, including polypropylene glycol 4-(methyl ether)-1,3-dioxolan-2-one oligomer compounds. The oligomer compounds are synthesized by carbonation in a high-pressure reactor, starting from the corresponding compounds comprising end groups having oxirane (or epoxide) final parts: the oxirane groups are converted into 1,3-dioxolan-2-one groups by carbonation. The 1,3-dioxolan-2-one oligomer compounds are subsequently mixed with amine oligomers so as to synthesize polyurethanes by crosslinking.

The polypropylene glycol 4-(methyl ether)-1,3-dioxolan-2-one oligomer compounds described in this document have a low molar mass, typically from 350 to 3200 g/mol, and a star-shaped structure comprising from 2 to 8 branches, each branch comprising a polypropylene glycol 4-(methyl ether)-1,3-dioxolan-2-one and all the branches being connected to one another by a hydro-carbon group. The 4-(methyl ether)-1,3-dioxolan-2-one group is as final part of the end group of each branch, the hydrocarbon group occurring at the other end of the branch. No example of the synthesis of a polypropylene glycol 4-(methyl ether)-1,3-dioxolane oligomer compound is described. However, the carbonation reaction is not complete since the oligomers comprise from 4 to 12% by weight of the starting oligomers, which is problematic during the formation of the polyurethanes.

The patent application WO 03/028644, from Eurotech Ltd, describes virtually pure 4-(methyl ether)-1,3-dioxolan-2-one oligomer compounds and in particular describes polypropylene glycol 4-(methyl ether)-1,3-dioxolan-2-one oligomer compounds of low molar mass, typically of 600 to 1600 g/mol. The structure of these oligomers is in the form of a star comprising from 3 to 6 branches, each branch comprising a polypropylene glycol 4-(methyl ether)-1,3-dioxolan-2-one and all the branches being connected to one another by a hydrocarbon group. The 4-(methyl ether)-1,3-dioxolan-2-one group is as final part of the end group of each branch, the hydrocarbon group occurring at the other end of the branch. No example of the synthesis of a polypropylene glycol 4-(methyl ether)-1,3-dioxolane oligomer compound is described.

It is an aim of the present invention to provide novel intermediates which make possible the synthesis of polyurethanes without using isocyanate.

Thus, the present invention relates to a polymer of formula (I) comprising at least one 4-(methyl ether)-1,3-dioxolan-2-one end group:

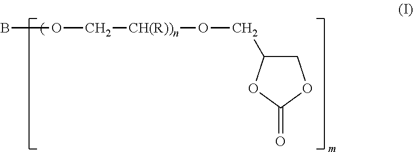

in which:
R is a hydrogen or an alkyl which comprises from 1 to 4 carbon atoms; preferably, R is hydrogen and/or a methyl radical;
m is a number from 1 to 6; preferably, m is chosen from 2 and 3; more preferably still, m is equal to 2;
B is a monovalent, divalent, trivalent, tetravalent, pentavalent or hexavalent radical, said radical generally comprising from 1 to 44 carbon atoms per molecule;
and n is such that the number-average molar mass Mn of the polymer of formula (I) is within a range from 4000 to 18 000 g/mol and such that the polydispersity (Pd) of the polymer of formula (I) is within a range from 1.0 to 1.4.

The polydispersity Pd is defined as the Mw/Mn ratio, that is to say the ratio of the weight-average molar mass to the number-average molar mass of the polymer.

The two molar masses Mn and Mw are measured according to the invention by size exclusion chromatography (SEC), usually with PEG (PolyEthylene Glycol) or PS (PolyStyrene) calibration.

End group is understood to mean a group located at the chain extremity (or end) of the polymer.

The radical B can be linear or branched, can comprise at least one saturated and/or unsaturated bond and can comprise at least one cyclic and/or alicyclic group.

The radical B is preferably chosen from the group formed by the radicals formed from the compounds methanol, ethylene glycol, propylene glycol, neopentyl glycol, fatty alcohol dimer, trimethylolpropane, pentaerythritol, glycerol, arabinol and sorbitol, by departure of at least one hydroxyl group.

The divalent polymeric radical —(—OCH₂—CH(R)—)ₙ— generally has a number-average molar mass within a range from approximately 667 to 18 000 g/mol.

The divalent polymeric radical —(—OCH₂—CH(R)—)ₙ— can be formed from a block or random copolymer of at least two divalent radicals of polymers, of formulae —(—OCH₂—CH(R1)-)ₙ₁- and —(—OCH₂—CH(R2)-)ₙ₂-, where n1 and n2 are such that the number-average molar mass Mn of the polymer of formula (I) is within a range from 4000 to 18 000 g/mol and such that the polydispersity (Pd) of the polymer of formula (I) is within a range from 1.0 to 1.4.

According to a preferred embodiment of the invention, the divalent polymeric radical —(—OCH₂—CH(R)—)ₙ— comprises a plurality of oxyalkylene repeat units, preferably oxyethylene, oxypropylene, oxybutylene and/or oxyhexylene repeat units.

According to a preferred embodiment of the invention, the divalent polymeric radical —(—OCH₂—CH(R)—)ₙ— is chosen from the group formed by polyoxyethylene, polyoxypropylene, polyoxybutylene and polyoxyhexylene radicals and their copolymers. The copolymers are generally block or random.

Preferably, the divalent radical —(—OCH₂—CH(R)—)ₙ— is formed from a polyether polyol chosen from the group formed by the copolymers formed from ethylene oxide and propylene oxide. The copolymers are generally block or random.

As is known to a person skilled in the art, these polyether polyols can be prepared by ring opening polymerization of an oxygen-comprising cyclic compound, such as a compound chosen from the group formed by ethylene oxide, propylene oxide and butylene oxide, often in the presence of an initiator, such as a monomeric diol.

The invention also relates to a process for the preparation of at least one polymer of formula (I) according to the invention, comprising a stage of carbonation of at least one polymer of formula (III) below, in which B, R, m and n have the same meanings as those of the formula (I):

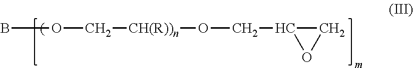

in the presence of CO₂, generally at a pressure of between 5×10⁴ and 2×10⁷ Pa (i.e., between 0.5 and 200 bar) and at a temperature of between 30 and 180° C., this stage preferably being carried out under supercritical conditions at a pressure of between 10⁷ and 2×10⁷ Pa (i.e. between 100 and 200 bar) and at a temperature of between 80 and 150° C. When the temperature is less than 80° C., the kinetics are generally much too slow and the activation energy is generally insufficient and, when the temperature is greater than 180° C., degradation of the catalyst is generally observed.

The carbonation stage is generally carried out as known to a person skilled in the art, at the pressure and at the temperature which are indicated above. Thus, the carbonation stage is generally carried out in the presence of CO₂ in any form, for example in the liquid, gas or supercritical state (depending on the reaction pressure), and of a reactant generally chosen from tetrabutylammonium bromide, tetrabutylammonium hydroxide and mixtures comprising tin tetrachloride (SnCl₄.5H₂O). The carbonation stage is preferably carried out in the presence of CO₂ in the supercritical state and of tetrabutylammonium bromide.

The carbonation stage is, for example, carried out according to the procedure described in the patent application WO 03/028644 or in the patent application FR 2 952 933.

In a preferred embodiment, the polymer of formula (III) is obtained by reaction of at least one polymer of formula (II), in which B, R, m and n have the same meanings as those of the formula (I):

B—[—(OCH₂—CH(R))ₙ—OH]ₘ (II),

with epichlorohydrin.

This reaction, which makes it possible to replace the end hydroxyl groups with oxirane (or epoxide) groups, can be carried out, for example, according to the procedure described in the patent U.S. Pat. No. 2,888,426 or else according to the procedure described in patent application JP 2007009158. It can be carried out in one or more stages.

Finally, the invention relates to a process for the preparation of polyurethanes comprising the reaction of at least one polymer of formula (I) according to the invention with at least one compound comprising at least one, preferably at least two, amine groups, for example chosen from amines, diamines, triamines and polyamines, and also to the polyurethanes capable of being obtained by this preparation process.

The amines are preferably such that at least one amine group, preferably all the amine groups, are primary amine groups.

The polyurethanes thus obtained, which are novel, are advantageously devoid of isocyanate.

These polyurethanes, once formulated (i.e., formulated with other optional additives), are intended to be used in coatings, mastics or adhesives, as fillers and/or as resins. It is also possible independently to formulate the polymer of formula (I) and the compound comprising at least one amine group, before they are mixed.

A better understanding of the invention will be obtained in the light of the examples which follow.

### EXAMPLES

The examples which follow illustrate the invention without, however, limiting the scope thereof.

The synthesis reactions of the examples were carried out according to the scheme below:

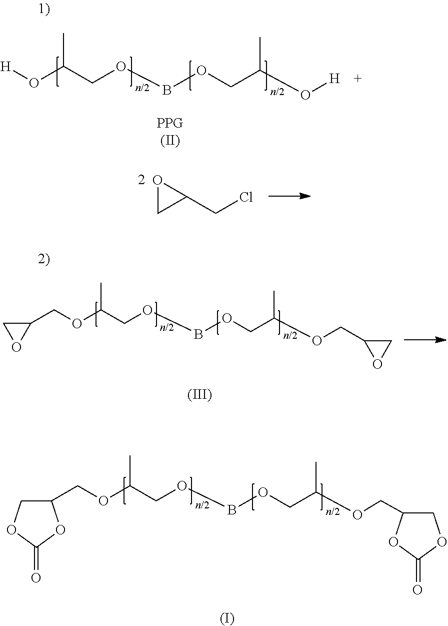

The compound (I) synthesized was such that m=2, R=methyl and B was a divalent propylene radical (—CH₂—CH(CH₃)—).

The PPG (PolyPropylene Glycol) starting material was either the Acclaim® Polyol 4200 commercial product (with a number-average molar mass Mn of 4000 g/mol) or the Acclaim® Polyol 18200 commercial product (with a number-average molar mass Mn of 18 000 g/mol), both these products being sold by Bayer Material Science. Each PPG had the formula:

HO—(—CH(CH₃)—CH₂—O—)_{n/2}—B—(—O—CH₂—CH(CH₃)—)_{n/2}—OH,

n being a function of the molar mass of the PPG.

1) Syntheses of the Polypropylene Glycol Diglycidyl Ethers of Formula (II)

Each of these two syntheses was carried out in two successive stages a) and b), in accordance with the protocol described in the patent U.S. Pat. No. 2,888,426.

Stage a): Addition of the Epichlorohydrin to the End Hydroxyl Groups of the Polypropylene Glycols

i. First Addition

2.5 mol of Acclaim® Polyol 4200 (Mn=4000) having an OH number of 28.0 mg KOH/g (10.0 g) were mixed with 30 cm³ of a 10% solution of boron trifluoride (BF₃) in ether (i.e., approximately from 2 to 3 g of BF₃). The mixture was heated up to approximately 80±3° C.

Approximately 7.5 mol of epichlorohydrin (699 g) were introduced over a period of 4 to 5 hours. After 8 to 10 hours, the reaction was complete and the excess of epichlorohydrin was removed under vacuum.

ii. Second Addition

2.5 mol of Acclaim® Polyol 18200 (Mn=18 000) having an OH number of 6.2 mg KOH/g (45.0 g) were mixed with 30 cm³ of a 10% solution of boron trifluoride (BF₃) in ether (i.e., approximately from 2 to 3 g of BF₃). The mixture was heated up to approximately 80±3° C. Approximately 7.5 mol of epichlorohydrin (699 g) were introduced over a period of 4 to 5 hours. After 16 to 18 hours, the reaction was complete and the excess of epichlorohydrin was removed under vacuum.

The products obtained had the following structure, whether the starting compound was an Acclaim® Polyol 4200 or an Acclaim® Polyol 18200:

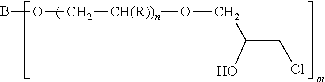

Stages b): Stages of Dehydrochlorination of the Products of Stage a)

1626 g of technical sodium aluminate were added to each of the two reaction media resulting from stage a), with 340 g of water and 5521 g of dioxane. Each time, the reaction medium was stirred at ambient temperature for 30 minutes and then heated and maintained at reflux of a condenser for 10 hours (approximately 95° C.). At the end of the 10 hours, the reaction medium was filtered and the filtration residue was washed with dioxane. The filtrate was brought to a temperature of 150° C. under reduced pressure (30 mmHg) in order to remove the water/dioxane mixture. The residue showed between 1.87 and 2.00 glycidyl ether radicals per mole of polypropylene glycol.

The overall yield for the combination of the two stages a) and b) was approximately 93% for each of the cases, calculated with regard to the initial polypropylene glycol, whether the Acclaim® Polyol 4200 or the Acclaim® Polyol 18200.

The final products were filtered separately through clay. It would also have been possible to filter them through a compound of active charcoal or equivalent type.

The products obtained had the following structure, whether the starting compound was an Acclaim® Polyol 4200 or an Acclaim® Polyol 18200:

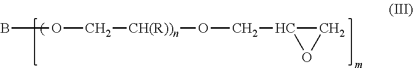

2) Synthesis of the di[polypropylene Glycol 4-(methyl ether)-1,3-dioxolan-2-one]s (Compounds of Formula (I))

This synthesis was carried out in accordance with the protocol described in the patent application WO 03/028644 or in the patent application FR 2 952 933.

The carbonation took place separately for each of the two compounds of formula (III) resulting from stage 1) in a high-pressure reactor in the presence of the polypropylene glycol diglycidyl ether resulting from stage 1) and of from 4 to 6% by weight of tetrabutyl-ammonium bromide (TBNBr). The reactor was heated to a temperature of 120° C. and then carbon dioxide was introduced until a pressure of at least 100 bar (1 bar =10⁵ Pa) was reached. The reaction was halted when the conversion of the epoxide functional groups was complete.

This carbonation stage was carried out in the presence of supercritical CO₂ and of tetrabutylammonium bromide at a temperature of approximately 120° C. and the carbon dioxide was introduced at a pressure of approximately 20 MPa.

The products thus obtained, respectively corresponding to the polyols Acclaim® Polyol 4200 and Acclaim® Polyol 18200, were each characterized by NMR: ¹H NMR (CDCL₃) ppm: 4.85 (bm, CH₃CH—O), 4.4-4.0 (m, 4H, CH₂—O 1,3-dioxolan-2-one), 3.65-3.25 (bm, CHO and CH₂ polymer), 3.2 (m, 2H, CHO 1,3-dioxolan-2-one), 2.8-2.6 (m, 4H, CH₂O 1,3-dioxolan-2-one), 1.25 (bs, CH₃ polymer). ¹³C NMR (CDCl₃) ppm: 155.7, 130.1, 129.2, 128.4, 125.4, 76.0-68.6, 68.2, 68.1, 49.2, 44.7, 17.4, 16.8.

They had the following structure, whether the starting compound was an Acclaim® Polyol 4200 or an Acclaim®

Polyol 18200:

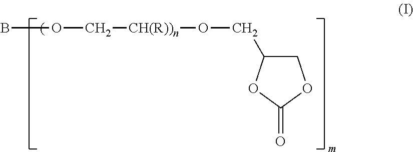

3. Synthesis of the Polyhydroxyurethanes Starting From the di[propylene Glycol 4-(methyl ether)-1,3-dioxolan-2-one]s of Example 2

A mixture of one of the di[propylene glycol 4-(methyl ether)-1,3-dioxolan-2-one]s of example 2 and of di(primary amine) of polyether diamine type (Jeffamine EDR 176, Huntsman) was reacted, separately, at 80° C. and in a stoichiometric ratio until complete disappearance of the infrared band characteristic of the 1,3-dioxolan-2-one groups (at 1800 cm⁻¹) and the appearance of the bands characteristic of the carbonate bond (band at 1700 cm⁻¹). The duration of the reaction was approximately 72 hours.

In each case, the product thus synthesized resulted in the formation of a polyhydroxyurethane, which two-component mixture, appropriately formulated, made it possible to obtain the desired adhesive properties.

1. A polymer of formula (I) comprising at least one 4-(methyl ether)-1,3-dioxolan-2-one end group: 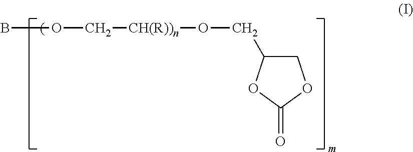
in which:
R is a hydrogen or an alkyl which comprises from 1 to 4 carbon atoms;
preferably, R is hydrogen and/or a methyl radical;
m is a number from 1 to 6; preferably, m is chosen from 2 and 3; more preferably still, m is equal to 2;
B is a monovalent, divalent, trivalent, tetravalent, pentavalent or hexavalent radical, said radical generally comprising from 1 to 44 carbon atoms per molecule;
and n is such that the number-average molar mass Mn of the polymer of formula (I) is within a range from 4000 to 18 000 g/mol and such that the polydispersity (Pd) of the polymer of formula (I) is within a range from 1.0 to 1.4.

2. The polymer as claimed in claim 1, said compound being such that the radical B is chosen from the group formed by the radicals formed from the compounds methanol, ethylene glycol, propylene glycol, neopentyl glycol, fatty alcohol dimer, trimethylolpropane, pentaerythritol, glycerol, arabinol and sorbitol, by departure of at least one hydroxyl group.

3. The polymer as claimed in claim 1, such that the divalent polymeric radical —(—OCH₂—CH(R)—)ₙ— comprises a plurality of oxyalkylene repeat units, preferably oxyethylene, oxypropylene, oxybutylene and/or oxyhexylene repeat units.

4. The polymer as claimed in claim 1, such that the divalent polymeric radical —(—OCH₂—CH(R)—)ₙ— is chosen from the group formed by the polyoxyethylene, polyoxypropylene, polyoxybutylene and polyoxyhexylene radicals and their copolymers.

5. The polymer as claimed in claim 1, such that the divalent polymeric radical —(—OCH₂—CH(R)—)ₙ— is formed from a polyether polyol chosen from the group formed by the copolymers produced from ethylene oxide and propylene oxide.

6. A process for the preparation of at least one polymer of formula (I) as claimed in claim 1, comprising a stage of carbonation of at least one polymer of formula (III) below, in which B, R, m and n have the same meanings as those of the formula (I): 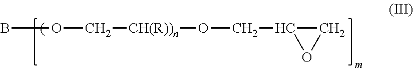
in the presence of CO₂, generally at a pressure of between 5×10⁴ and 2×10⁷ Pa and at a temperature of between 30 and 180° C., this stage preferably being carried out under supercritical conditions at a pressure of between 10⁷ and 2×10⁷ Pa and at a temperature of between 80 and 150° C.

7. The preparation process as claimed in claim 6, such that the polymer of formula (III) is obtained by reaction of at least one polymer of formula (II), in which B, R, m and n have the same meanings as those of the formula (I):
B—[—(OCH₂—CH(ROOₙ—OH]ₘ (II),
with epichlorohydrin.

8. A process for the preparation of polyurethanes comprising the reaction of at least one polymer of formula (I) as claimed in claim 1 with at least one compound comprising at least one, preferably at least two, amine groups, for example chosen from amines, diamines, triamines and polyamines.

9. A polyurethane capable of being obtained by the preparation process as claimed in claim 8.
